(19) United States
(12) Patent Application Publication
(10) Pub. No.: US 2021/0283699 A1
(43) Pub. Date: Sep. 16, 2021

(54) TANGENTIAL CUTTING INSERT AND A MILLING TOOL

(71) Applicant: AB SANDVIK COROMANT, Sandviken (SE)

(72) Inventors: Jeremy SCHMITT, Druye (FR); Herve UZENOT, Villorceau (FR); Yannick SARTON, Luynes (FR)

(21) Appl. No.: 17/258,468

(22) PCT Filed: Mar. 25, 2019
(86) PCT No.: PCT/EP2019/057360

§ 371 Date: Jan. 7, 2021

(30) Foreign Application Priority Data
Jul. 10, 2018 (EP) 18182674.4

(51) Int. Cl. B23C 5/10

(52) U.S. Cl. CPC B23C 5/109

(57) ABSTRACT

A tangential cutting insert includes two opposing main surfaces having a triangular shape, three identical side surfaces extending between the main surfaces, and at least three identical and indexable major cutting edges formed at the intersection of at least one of the main surfaces and the three identical side surfaces. Each side surface includes three flat support surfaces recessed in relation to the major cutting edge and arranged one after another in a longitudinal direction of each side surface. A first flat support surface is disposed centrally in each side surface and forms the lowermost recessed support surface in relation to the major cutting edge. Second and third flat support surfaces are located on opposite sides of the first flat support surface and extend at an obtuse angle with the first flat support surface. A milling tool having a plurality of insert seats receiving the tangential cutting insert is provided.

### TECHNICAL FIELD OF THE INVENTION

The invention relates to a tangential cutting insert and a milling tool for chip-removing machining, and particularly to a so called long edge milling cutter equipped with the tangential cutting insert.

### BACKGROUND OF THE INVENTION AND PRIOR ART

The invention is related to problems of reduced tool life in a milling tool caused by large cutting forces acting on the cutting edges of the tangential cutting inserts mounted in insert seats of the milling tool. Such large cutting forces are particularly problematic in a so called long edge milling cutter, also known as an extended flute end mill, typically used for milling deep shoulders at large axial cutting depths in a workpiece. The long edge milling cutter (or extended flute end mill) comprises a plurality of cutting inserts and insert seats placed one after the other in a common flute extending along a tool body of the milling tool. Such milling tools are suitable for deeper, larger and heavier milling applications, since the long edge milling cutter has a large metal removal capacity. However, the cutting forces are considerable making this a tough milling application. Moreover, the large cutting forces may vary in direction due to for instance up- and/or down-ramping operations performed with the long edge milling cutter. If the cutting insert is inadequately supported in the insert seat of the tool body, the large and/or varying cutting forces will make the cutting insert move slightly in the insert seat, wherein even small movements (micro-movements) will not just generate poor surface quality in the machined workpiece, but also cause an increased wear on the cutting insert itself. Additionally, the insert seat in the tool body of the milling tool may undergo plastic deformation caused by such large and/or varying cutting forces. More precisely, the insert seat comprises several contact surfaces abutting several support surfaces of the cutting insert, wherein the contact surfaces in the insert seat will gradually deteriorate due to the load of the cutting forces. The tool body of the milling tool is considered worn out when the plastic deformation of the contact surfaces in the insert seat has become too severe (i.e. the insert seat no longer provides accurate and stable support). Furthermore, while it is possible to limit the cutting forces by using an end mill or shoulder mill of limited (single cutting insert) height and machine deep shoulders or grooves in several passes, the economics (productivity requirements) in certain machining applications (in for instance aerospace industry) push toward larger cutting depths, which is particularly suitable for the long edge milling cutter (extended flute end mill). Although the mentioned problems of reduced tool life are also present in end mills/shoulder mills of limited (single cutting insert) height, the expected tool life of the long edge milling cutter is often less than 20% of a comparable (single cutting insert height) shoulder/end milling tool due to the severe demands put on such tools. Consequently, there is a desire to improve the performance and useful tool life of the long edge milling cutter.

EP2404690 discloses a long edge milling cutter comprising tangential cutting inserts configured for stable and accurate support in the insert seat. The tangential cutting insert is hereby configured with a first side forming a rake surface and an opposing second side forming a v-shaped seating surface for supporting the tangential cutting insert. One disadvantage with such a design is that the tangential insert only has one rake surface with two indexable (first and second) cutting edges, since the opposing second side (seating) surface is dedicated for supporting the tangential cutting insert. It would therefore be beneficial if an increased number of indexable cutting edges (rake faces) could be achieved, while ensuring a stable support of the tangential cutting insert.

U.S. Pat. No. 9,296,054 discloses a tangential cutting insert for a shoulder milling tool. The shoulder mill is of limited (single cutting insert) height. However, the tangential cutting insert is an indexable and triangular shaped cutting insert that provides an increased number of indexable cutting edges (six indexable major cutting edges) compared to the tangential cutting insert disclosed in EP2404690. Furthermore, each side of the tangential cutting insert comprises two planar seating surfaces formed at an angle with respect to a connection portion, wherein the two planar seating surfaces form recesses being countersunk in relation to the cutting edges to give the cutting edges a positive rake angle to easily cut the workpiece. The two seating surfaces are used together with a first or second (main) surface to provide three-point contact when the tangential cutting insert is in the mounted position. The cutting insert is thereby described as having an exceptional seating stability. However, it would be desirable to increase the seating stability and cutting performance even further, particularly since the entire major cutting edge of the tangential cutting insert is typically engaging the workpiece in a long edge milling cutter (or extended flute end mill) used for machining at large axial cutting depths.

### SUMMARY OF THE INVENTION

The object of the present invention is that of providing a tangential cutting insert and a milling tool having an improved stability in the support of the tangential cutting insert that also exhibits an effective cutting geometry. The support is hereby aimed at withstanding relatively large cutting forces that may vary in direction during up- and/or down-ramping performed in a milling operation with for instance a long edge milling cutter. In other words, the object is that of prolonging the tool life by improved insert retention security in combination with enhanced cutting performance.

The object is achieved by a tangential cutting insert as defined in claim 1. The triangular basic shape of the tangential cutting insert hereby includes three flat support surfaces in each side surface for a stable fixation/support of the tangential cutting insert and an efficient distribution of said large and/or varying cutting forces. The three flat support surfaces are furthermore recessed in relation to the major cutting edge to provide a positive rake angle and an enhanced/easy cutting action along the entire major cutting edge extension. Hence, a first flat support surface is disposed at a centre of each side surface and is forming the lowermost recessed support surface in relation to the major cutting edge, wherein the second and third flat support surfaces are located on opposite sides of the first flat support surface and extend at an obtuse angle with the first flat support surface. The tangential cutting insert can in this way provide three distinct, differently oriented and relatively large flat support surfaces in each side surface, which can interchangeably engage three corresponding seat contact surfaces to effectively constrain insert movement and safeguard the integrity (reduce load/plastic deformation) on the seat contact surfaces by providing a beneficial distribution of large cutting forces acting in different directions. Accordingly, a first contact surface in the seat of the tool body can be arranged to provide support against the first flat support surface at the centre on one side surface of the tangential cutting insert, wherein a second and third contact surface in the seat of the tool body can be arranged to provide support against the second and third flat support surface respectively on another side surface of the tangential cutting insert. This provides said stable support and efficient distribution of the large/varying cutting forces, which are also effectively reduced by the enhanced/easy cutting action by a positive rake angle along the major cutting edge that is provided by the recessed flat support surfaces. An improved tool life is therefore achieved.

In an embodiment of the tangential cutting insert, the first flat support surface extends in parallel with the major cutting edge. This provides a beneficial symmetry in terms of cutting performance and support along the centre of the side surface and the major cutting edge. Such symmetry is also beneficial in allowing the cutting insert to be designed as a double-sided tangential cutting insert that can reversed with an additional set of three identical and indexable cutting edges at the intersection of the other main surface and the three identical side surfaces. In addition, if the tangential cutting insert is designed as a double-sided cutting insert, the obtuse angle at which the second and third support surface extend with respect to the first support surface are of equal size (yet directed in opposite directions as the oppositely located second and third support surface ramp upwards from the lowermost recessed first support surface).

In another embodiment of the tangential cutting insert, the first flat support surface is relatively larger by having a longer extension than each one of the second and third flat support surfaces as seen in the longitudinal direction of each side surface. In this way, the cutting forces and load distribution between the seat contact surfaces is made more even, since the first flat support surface is aimed at supporting the insert in one direction and the second and third support surfaces collectively support in other directions.

In a further embodiment of the tangential cutting insert, the first flat support surface is 30%-70% longer than each one of the second and third flat support surfaces as seen in the longitudinal direction of each side surface. The relative lengths are hereby measured in a longitudinal direction that is located and extending along a middle/centre of each side surface (where the tangential cutting insert in general is being supported). Hence, as mentioned above, the loads on the seat contact surfaces are more evenly distributed, since the first flat support surface, which is supporting the insert against a single contact surface in the seat, is 30%-70% longer than the second or third support surface that collectively support the insert in their respective directions.

In an embodiment of the tangential cutting insert, the second and third flat support surfaces are of equal size and length as seen in in the longitudinal direction of each side surface. This provides a symmetry in the support provided by the second and third flat support surfaces, whereby the load on the second and third contact surfaces in the seat is distributed more evenly. Furthermore, as previously mentioned, this symmetry is also beneficial in providing the same cutting performance and support in case the tangential cutting insert is designed as a double-sided tangential cutting insert that can be reversed with an additional set of three identical and indexable cutting edges at the intersection of the other main surface and the three identical side surfaces. In addition, it is once emphasized that the obtuse angle at which the second and third support surface extend with respect to the first support surface should be of equal size (yet directed in opposite directions, since the oppositely located second and third support surface ramp upwards from the lowermost recessed first support surface) in case the tangential cutting insert is a double-sided insert.

In another embodiment of the tangential cutting insert, the three flat support surfaces have substantially an equal width extension as seen in a direction transverse the longitudinal direction of each side surface. This contributes to an equal pressure distribution/load and furthermore provides a beneficial symmetry in support and cutting performance in case the tangential cutting insert is designed as a double-sided tangential cutting insert that can be reversed with an additional set of three identical and indexable cutting edges at the intersection of the other main surface and the three identical side surfaces.

In an embodiment of the tangential cutting insert, the obtuse angle is larger than 150°, and preferably larger than 160°. Such an obtuse angle between the first flat support surface and the second/third flat support surface contributes to said beneficial distribution of large cutting forces acting in different directions. Hence, it provides a stable support and an efficient distribution of the large/varying cutting forces, which are also effectively reduced by the enhanced/easy cutting action provided by the positive rake angle of the recessed flat support surfaces.

In another embodiment of the tangential cutting insert, the three flat support surfaces are arranged successively and extend along the entire side surface as seen in the longitudinal direction. In other words, the whole longitudinal extension of each side surface can in this way be used for support to distribute the cutting forces and reduce the load on each contact surface in the seat. The insert hereby merely includes small transition surfaces arranged between the three differently oriented flat support surfaces in each side surface as well as small radius transitions surfaces as the ends of each third/second flat support surface (corners of the insert).

In yet another embodiment of the tangential cutting insert, each major cutting edge has an adjacent rake surface in the respective side surface, wherein the rake surface extends at a positive rake angle between the entire major cutting edge and the three flat support surfaces. The rake surface may preferably have a uniform width and rake angle between the major cutting edge and the first flat support surface, wherein the width and rake angle on the rake surface successively decreases between major cutting edge and the oppositely located second and third flat support surfaces.

In yet another embodiment the tangential cutting insert is a double-sided tangential cutting insert including six identical and indexable major cutting edges formed at the intersections of each of said two opposing main surfaces and the three identical side surfaces, wherein the three flat support surfaces of each side surface are recessed in relation to two opposite and indexable major cutting edges.

The object is achieved by a milling tool as defined in claim 11. The milling tool comprises a tool body being rotatable around a central rotation axis and has a plurality of insert seats configured to receive the tangential cutting insert as defined above. The tool body has a front end and a rear end, wherein each insert seat is formed in an envelope surface extending between the front end and the rear end of the tool body. A bottom of the insert seat comprises a main contact surface arranged to provide support against the main surface of the tangential cutting insert. A first side wall of the insert seat comprises a first contact surface arranged to provide support against the first flat support surface on one side surface of the tangential cutting insert. A second side wall of the insert seat comprises a second and third contact surface arranged to provide support against the second and third flat support surfaces respectively on another side surface of the tangential cutting insert. In other words, the second and third contact surfaces of the second side wall are arranged at an internal obtuse angle in relation to each other. The internal obtuse angle formed between the second and third contact surfaces of the seat is hereby equal to the angle formed between the second and third support surfaces of the insert (i.e. 180° minus the obtuse angles β formed between first support surface and second support surface as well as the third support surface). The milling tool thereby provides an improved stability in the support of the tangential cutting insert, wherein contact surfaces in the insert seat are configured to withstand relatively large cutting forces that may vary in direction during up- and/or down-ramping performed in a milling operation with for instance a long edge milling cutter. The insert seat in the tool body can in this way provide three distinct, differently oriented and relatively large contact surfaces for supporting the three corresponding support surfaces to effectively constrain insert movement and safeguard the integrity (reduce load/plastic deformation) on the seat contact surfaces by providing a beneficial distribution of large cutting forces acting in different directions. Consequently, this improves the performance and useful tool life of the milling tool.

In an embodiment of the milling tool, the first side wall of the insert seat is located closer to the rear end of the tool body in relation to the second side wall, which is located closer to the front end of the tool body, in each of said insert seats. The first contact surface is hereby located on the first side wall, which is arranged closer to the rear end, whereby the relatively large/long first contact surface/support surface can support a relatively large (tangential) force component of the cutting forces.

In a preferred embodiment, the milling tool is a long edge milling cutter, wherein the tool body comprises a cylindrical envelope surface, and the plurality of insert seats are placed one after the other in a common helix flute along the cylindrical envelope surface of the tool body. As previously mentioned, such milling tools are suitable for deeper, larger and heavier milling applications, since the long edge milling cutter has a large metal removal capacity. The long edge milling cutter comprises several helix flutes along the cylindrical envelope surface of the tool body. The cutting forces are considerable making this a tough milling application, wherein the large cutting forces may also vary in direction due to for instance up- and/or down-ramping operations performed with the long edge milling cutter. Accordingly, the invention is suitably used for prolonging the useful tool life of the long edge milling cutter.

In a further preferred embodiment of the long edge milling cutter, the major cutting edge of a tangential cutting insert, which is received in an insert seat placed relatively closer to the front end in the common helix flute, is arranged to overlap a portion of the next major cutting edge of an adjacent tangential cutting insert, which is received in an insert seat placed relatively closer to the rear end in the common helix flute. This provides an uninterrupted (continuous) cutting edge formed collectively by the major cutting edges along the common helix flute of the long edge milling cutter.

In another embodiment of the milling tool, each insert seat is configured with an orientation on said contact surfaces in the first and second side walls so that the active major cutting edge is extending at a positive axial rake angle in relation to the central rotation axis when the tangential cutting insert is received in the insert seat. This provides a positive/easy cutting action and beneficial chip evacuation as the major cutting edge gradually enters the workpiece at said positive axial rake angle. Such positive axial rake angle can also enhance the toughness of the major cutting edge that may withstand relatively higher cutting forces without breaking or chipping.

### BRIEF DESCRIPTION OF THE DRAWINGS

Embodiments are described with references to the drawings, in which:

FIG. 1a shows a side view of a milling tool in the form of a long edge milling cutter,

FIG. 1b shows a perspective view of the milling tool/long edge milling cutter,

FIGS. 2a-d show side views of a tangential cutting insert mounted in the milling tool/long edge milling cutter,

FIGS. 3a-d show a side view of the mounted tangential cutting insert including different cross-sections IIIb-IIIb to IIId-IIId showing the support of the tangential cutting insert,

FIGS. 4a-d show a perspective view of the tangential cutting insert including different side views and a main planar view of the tangential cutting insert.

### DETAILED DESCRIPTION OF EMBODIMENTS OF THE INVENTION

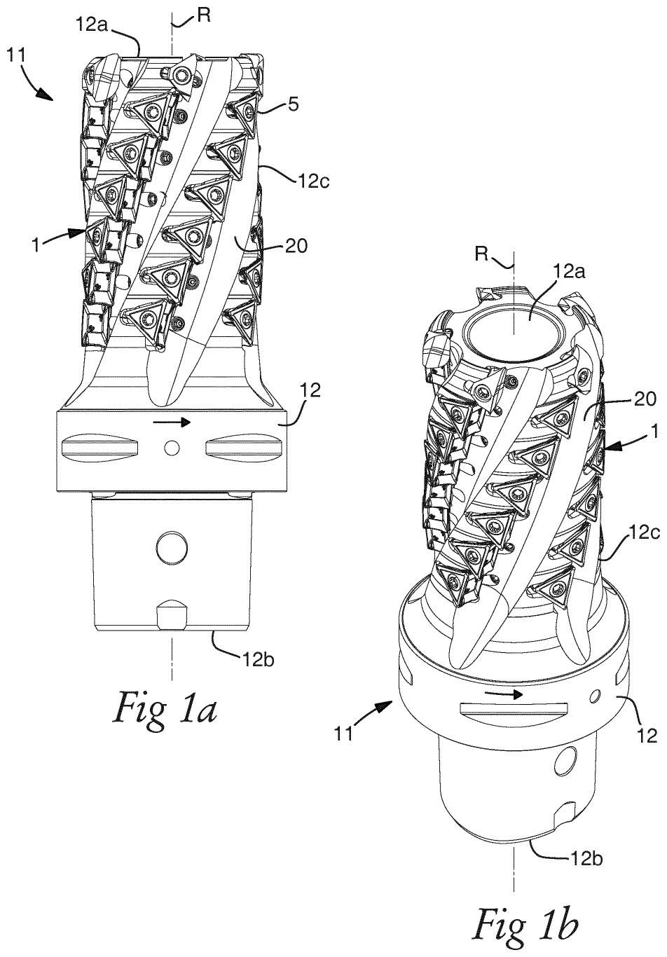

FIGS. 1a-1b show different views of a milling tool 11 according to an embodiment of the invention. The milling tool is a long edge milling cutter 11 comprising a tool body 12 being rotatable around a central rotation axis R. The tool body has a front end 12a and a rear end 12b, which is configured to be mounted to a spindle of a milling machine (not shown). The tool body 12 comprises a plurality of insert seats 13 being formed in a cylindrical envelope surface 12c of the tool body. The insert seats 13 are placed one after the other in a common helix flute 20 extending along the cylindrical envelope surface 12c of the tool body 12. This specific embodiment comprises five helix flutes 20 along the envelope surface 12c of the tool body 12. The insert seats 13 (except an axially foremost insert seat arranged at the front end 12a) are configured to receive a tangential cutting insert 1 according to an embodiment of the invention.

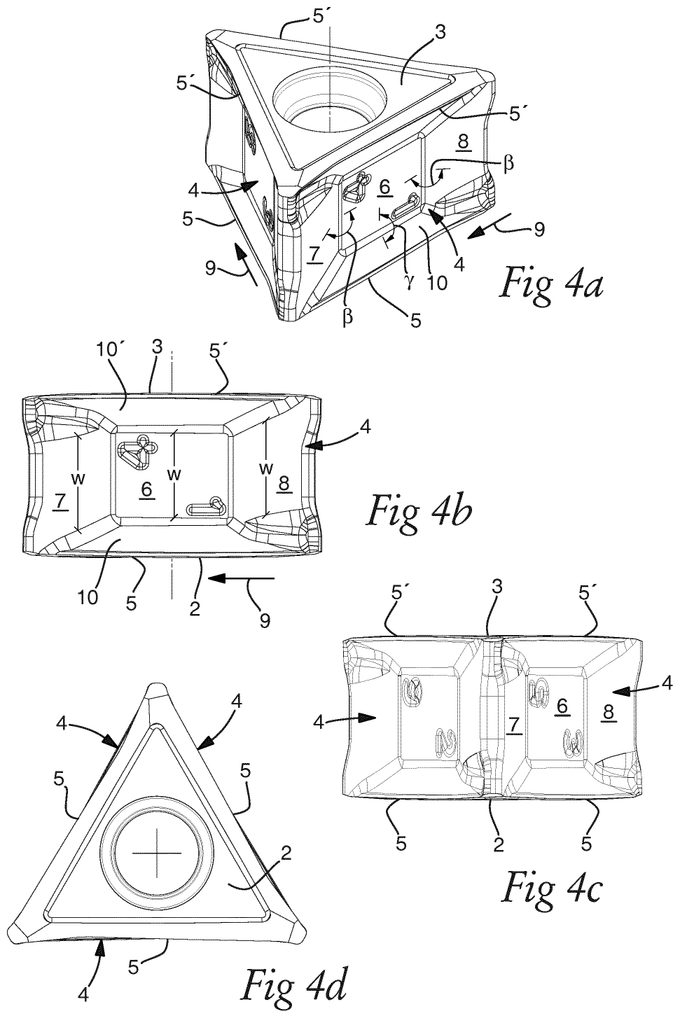

FIGS. 4a-4d show different views of the tangential cutting insert 1 of the embodiment. The tangential cutting insert 1 comprises two opposing main surfaces 2, 3 having a triangular shape and three identical side surfaces 4 extending between the main surfaces 2, 3. The tangential cutting insert 1 includes three identical and indexable major cutting edges 5 formed at the intersection of one main surface 2 and the three identical side surfaces 4.

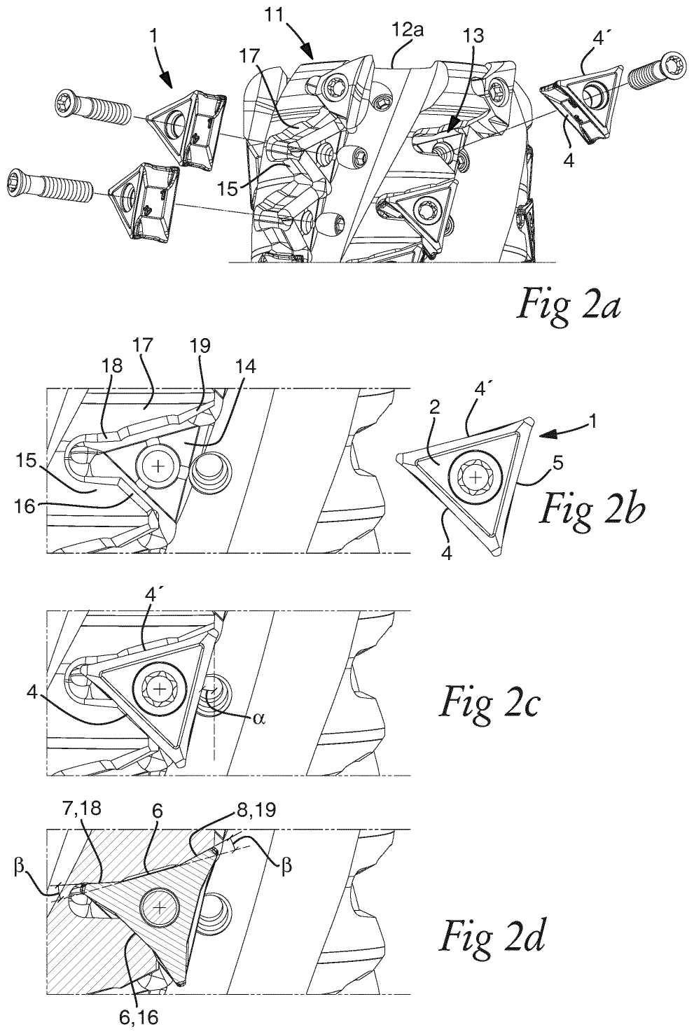

Furthermore, as can be seen, the embodiment is a double-sided tangential cutting insert including an additional set of three identical and indexable major cutting edge 5′ formed at the intersection of the other main surface 3 and the three identical side surfaces 4. Hence, the double-sided tangential cutting insert includes six identical and indexable major cutting edges 5, 5′. Each side surface 4 includes three flat support surfaces 6, 7, 8 being recessed in relation to the major cutting edges 5, 5′. The three flat support surfaces 6, 7, 8 are arranged one after the other in a longitudinal direction 9 of each side surface 4, wherein a first flat support surface 6 is disposed a centre of each side surface 4 and is forming the lowermost recessed support surface in relation to the major cutting edge 5. The second and third flat support surfaces 7, 8 are located on opposite sides of the first flat support surface 6 and extend at an obtuse angle β with the first flat support surface 6 (see also FIG. 2d).

Accordingly, the double-sided and triangular shaped tangential cutting insert 1 is provided with the three flat support surfaces 6, 7, 8 in each side surface 4 for a stable fixation/support of the tangential cutting insert 1 and an efficient distribution of large and/or varying cutting forces. As can be seen, the three flat support surfaces 6, 7, 8 are also recessed in relation to the major cutting edge 5, 5′ to provide a positive rake angle γ and an enhanced/easy cutting action along the extension of the major cutting edge 5, 5′. The first flat support surface 6 is disposed at a centre of each side surface 4, 4′ and is forming the lowermost recessed support surface in relation to the major cutting edge 5, 5′, wherein the second and third flat support surfaces 7, 8 are located on opposite sides of the first flat support surface 6 and extend at an obtuse angle β with the first flat support surface 6.

The obtuse angle β between the first and second or third flat supports surfaces is larger than 150°, and preferably larger than 160°. More precisely, in the shown embodiment the obtuse angle β is 167.5°. The first flat support surface 6 extends in parallel with the major cutting edge 5, 5′. Furthermore, the first flat support surface 6 is relatively larger by having a longer extension that each one of the second and third flat support surface 7, 8 in the longitudinal direction 9 of each side surface 4. The cutting forces/loads are hereby beneficially distributed in the insert seat, since the first flat support surface 6 will support the tangential cutting insert in one direction and the second and third support surfaces 7, 8 collectively support the tangential cutting insert in other directions. In the embodiment, the first flat support surface 6 is approximately 40% longer than the second or third flat support surface 7, 8 as seen in the longitudinal direction 9 in the middle of each side surface 4. As can be seen in the figures the second and third support surfaces 7, 8 is slightly longer if measure in a longitudinal direction 9, which is located nearer either of the major cutting edges 5, 5′. The effective length of each support surface 6, 7, 8 for supporting the insert should in this case be considered when comparing the relative lengths between the support surfaces 6, 7, 8. Hence, in this embodiment, the relative lengths are measured along the middle of each side surface 4, 4′ of the insert.

The second and third flat support surfaces 7, 8 are of equal size and length in the longitudinal direction 9 of each side surface 4. This provides a symmetry in the support/load on the second and third flat support surfaces 7, 8. Furthermore, this symmetry also provides the same cutting performance as the double-sided tangential cutting insert 1 is reversed with the additional set of three identical and indexable cutting edges 5′ at the intersection of the other main surface 3 and the three identical side surfaces 4, 4′.

Moreover, the three flat support surfaces 6, 7, 8 are arranged successively and extend along the entire side surface 4, 4′ as seen in the longitudinal direction 9. Accordingly, the three flat support surfaces 6, 7, 8 extend along the whole longitudinal extension of each side surface 4, 4′ to enhance the beneficial distribution of the cutting forces and further reduce the load on each contact surface in the insert seat 13. As can be seen, the tangential cutting insert hereby merely includes small transition surfaces arranged between the three differently oriented flat support surfaces 6, 7, 8 in each side surface 4, 4′ as well as small radius transitions surfaces as the ends of each third/second flat support surface 7, 8 (corners of the insert). The shown three flat support surface 6, 7, 8 also have substantially an equal width W as seen in a direction transverse (perpendicular) to the longitudinal direction 9 of the side surface 4. Each major cutting edge 5, 5′ has an adjacent rake surface 10, 10′ in the side surface 4, wherein the rake surface 10 extends at a positive rake angle γ between the entire major cutting edge 5, 5′ and the tree flat support surfaces 6, 7, 8. The rake surface 10, 10′ has a uniform width and rake angle γ between the major cutting edge 5, 5′ and the first flat support surface 6, wherein the width on the rake surface 10, 10′ successively decreases between major cutting edge 5, 5′ and the second and third flat support surfaces 7, 8 in a direction toward the corners of the insert.

FIGS. 2a-2d show the tangential cutting insert 1 mounted in the insert seat 13 of the tool body 12. A bottom of the insert seat 13 comprises a main contact surface 14 arranged to provide support against the main surface 2, 3 of the tangential cutting insert 1. A first side wall 15 of the insert seat 13 comprises a first contact surface 16 arranged to provide support against the first flat support surface 6 on one side surface 4 of the tangential cutting insert 1. A second side wall 17 of the insert seat 13 comprises a second and third contact surface 18, 19 arranged to provide support against the second and third flat support surfaces 7, 8 respectively on another side surface 4′ of the tangential cutting insert 1. The first side wall 15 of each insert seat 13 is located closer to the rear end 12b of the tool body 12 in relation to the second side wall 17, which is located closer to the front end 12a of the tool body 12.

As previously mentioned, the tangential cutting insert 1 is hereby supported by three distinct, differently oriented and relatively large flat support surfaces 6, 7, 8 in each side surface 4, 4′, which are abutting three corresponding seat contact surfaces 16, 18, 19 to effectively constrain insert movement and safeguard the integrity (reduce load/plastic deformation) on the seat contact surfaces 16, 18, 19. This achieves a stable support and efficient distribution of the large/varying cutting forces, which are also effectively reduced by the enhanced/easy cutting action provided by the recessed flat support surfaces 6, 7, 8.

Furthermore, each insert seat 13 is configured with an orientation on said contact surfaces 16, 18, 19 in the first and second side walls 15, 17 so that the active major cutting edge 5 is extending at a positive axial rake angle α in relation to the central rotation axis R when the tangential cutting insert is mounted in the insert seat 13. This further contributes to a positive/easy cutting action and a beneficial chip evacuation as the major cutting edge gradually enters the workpiece at said positive axial rake angle α. The positive axial rake angle α further enhances the toughness behaviour of the major cutting edge 5, 5′ such that it may withstand relatively higher cutting forces without breaking or chipping.

A major cutting edge 5 on a tangential cutting insert 1, which is received in an insert seat 13 placed relatively closer to the front end 12a in the common helix flute 20, is arranged to overlap a portion of the next major cutting edge 5 of an adjacent tangential cutting insert 1, which is received in an insert seat 13 placed relatively closer to the rear end 12b in the common helix flute 20 (see also FIGS. 1a-1b). Hence, an end portion on the major cutting edge 5 on a leading tangential cutting insert 1 is arranged to overlap an initial portion on the adjacent major cutting edge 5 on a trailing (rear) tangential cutting insert 1 in the common helix flute 20. This provides an uninterrupted (axially continuous, but tangentially stepwise) single cutting edge configuration formed collectively by the major cutting edges 5 along the common helix flute 20 of the long edge milling cutter 11.

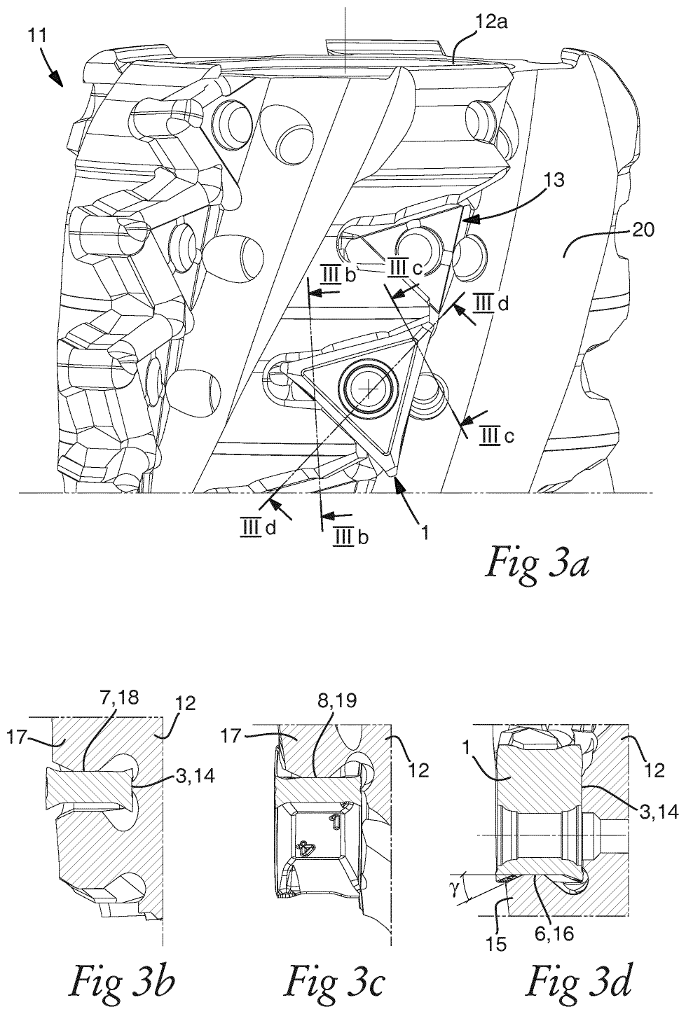

FIGS. 3a-3d show an enlarged view of the insert seat including different cross-sections of the tangential cutting insert 1 arranged in the insert seat 13 of the tool body 12. FIG. 3b is showing cross-section IIIb-IIIb in FIG. 3a. As can be seen, FIG. 3b shows the second flat support surface 7 of the tangential cutting insert 1 abutting a corresponding flat second contact surface 18 of the second side wall 17 in the insert seat 13. The cross-section is also showing the main surface 3 of the tangential cutting insert abutting the main contact surface 14 in the bottom of the insert seat 13. FIG. 3c is showing cross-section IIIc-IIIc in FIG. 3a. FIG. 3c shows the third flat support surface 8 of the tangential cutting insert abutting a corresponding flat third contact surface 19 of the second side wall 17 in the insert seat 13. FIG. 3d is showing cross-section IIId-IIId in FIG. 3a. FIG. 3d shows the first flat support surface 6 abutting a corresponding flat first contact surface 16 of the first side wall 15 in the insert seat 13.

The invention is not limited to the embodiment disclosed but may be varied and modified within the scope of the appended claims. For example, the tangential cutting insert may be formed as a single-sided insert with three indexable major cutting edges at the intersection of only one main surface and the three side surfaces.

1. A tangential cutting insert for a milling tool, the tangential cutting insert comprising:
two opposing main surfaces having a triangular shape; and
three identical side surfaces extending between the main surfaces; and
at least three identical and indexable major cutting edges formed at the intersection of at least one of the main surfaces and the three identical side surfaces, wherein each side surface includes three flat support surfaces being recessed in relation to the major cutting edge and arranged one after another in a longitudinal direction of each side surface, wherein a first flat support surface is disposed at a centre of each side surface and and forms a lowermost recessed support surface in relation to the major cutting edge, and wherein second and third flat support surfaces are located on opposite sides of the first flat support surface and extends at an obtuse angle with the first flat support surface.

2. The tangential cutting insert according to claim 1, wherein the first flat support surface extends in parallel with the major cutting edge.

3. The tangential cutting insert according to claim 1, wherein the first flat support surface is larger, by having a longer extension, than each one of the second and third flat support surfaces in the longitudinal direction of each side surface.

4. The tangential cutting insert according to claim 3, wherein the first flat support surface is 30%-70% longer than each one of the second and third flat support surfaces in the longitudinal direction of each side surface.

5. The tangential cutting insert according to claim 1, wherein the second and third flat support surfaces are of equal size and length in the longitudinal direction of each side surface.

6. The tangential cutting insert according to claim 1, wherein the three flat support surfaces have substantially an equal width extension as seen in a direction transverse the longitudinal direction of each side surface.

7. The tangential cutting insert according to claim 1, wherein the obtuse angle is larger than 150°, and preferably larger than 160°.

8. The tangential cutting insert according to claim 1, wherein the three flat support surfaces are arranged successively and extend along the entire side surface as seen in the longitudinal direction.

9. The tangential cutting insert according to claim 1, wherein each major cutting edge has an adjacent rake surface in the side surface, wherein the rake surface extends at a positive rake angle between the entire major cutting edge and three flat support surfaces.

10. The tangential cutting insert according to claim 1, wherein the tangential cutting insert is a double-sided tangential cutting insert including six identical and indexable major cutting edges formed at the intersections of each of said two opposing main surfaces and the three identical side surfaces, wherein the three flat support surfaces of each side surface are recessed in relation to two opposite indexable major cutting edges.

11. A milling tool comprising a tool body rotatable around a central rotation axis and having a plurality of insert seats configured to receive a tangential cutting insert according to claim 1, wherein the tool body has a front end and a rear end, each insert seat being formed in an envelope surface extending between the front end and the rear end of the tool body, wherein a bottom of the insert seat includes a main contact surface arranged to provide support against the main surface of the tangential cutting insert, a first side wall of the insert seat including a first contact surface arranged to provide support against the first flat support surface on one side surface of the tangential cutting insert, and a second side wall of the insert seat including a second and third contact surface arranged to provide support against the second and third flat support surfaces respectively on another side surface of the tangential cutting insert.

12. The milling tool according to claim 11, wherein the first side wall of the insert seat is located closer to the rear end of the tool body in relation to the second side wall, which is located closer to the front end of the tool body, in each of said insert seats.

13. The milling tool according to claim 11, wherein the milling tool is a long edge milling cutter, the tool body including a cylindrical envelope surface, wherein the plurality of insert seats are placed one after the other in a common helix flute along the cylindrical envelope surface of the tool body.

14. The milling tool according to claim 13, wherein the major cutting edge of the tangential cutting insert, which is received in an insert seat placed relatively closer to the front end in the common helix flute, is arranged to overlap a portion of the next major cutting edge of an adjacent tangential cutting insert, which is received in an insert seat placed relatively closer to the rear end in the common helix flute.

15. The milling tool according to claim 11, wherein each insert seat is configured with an orientation on said contact surfaces in the first and second side walls so that the active major cutting edge extends at a positive axial rake angle in relation to the central rotation axis when the tangential cutting insert is received in the insert seat.
